(19) United States
(12) Patent Application Publication
(10) Pub. No.: US 2013/0101823 A1
(43) Pub. Date: Apr. 25, 2013

(54) FOAM MATERIAL WITH ORDERED VOIDS

(71) Applicants: Terry M. Sanderson, Tucson, AZ (US); David R. Sar, Corona, CA (US); Jack W. Reany, Corona de Tucson, AZ (US)

(72) Inventors: Terry M. Sanderson, Tucson, AZ (US); David R. Sar, Corona, CA (US); Jack W. Reany, Corona de Tucson, AZ (US)

(21) Appl. No.: 13/278,501

(22) Filed: Oct. 21, 2011

(51) Int. Cl. B32B 5/18

(52) U.S. Cl. 428/221

(57) ABSTRACT

A foam material is an open-cell material, with ordered voids forming an interconnected network of voids within a continuous material matrix. The voids may be spherical. There may be different sizes of voids, with the smaller voids located between larger voids. The continuous material matrix may include a polymer material, such as a shape memory polymer. Balloons or spheres may be included within the continuous material matrix to further reduce the density of the foam material. The foam material may have a global density of 20% or less. The density of the material may vary, perhaps continuously, with position within the foam material. The foam material may be made by producing an array of a removable material corresponding to the shape of the voids, forming the continuous material matrix around the removable material, and then removing the removable material, such as by dissolving the removable material.

### BACKGROUND OF THE INVENTION

1. Field of the Invention

The present invention is in the field of foam materials.

2. Description of the Related Art

There is an ongoing need to develop structural materials that take up a small volume in a stowed state, and deploy to a much larger size. One example is an airplane wing that is expandable, as shown in U.S. Pat. Nos. 7,939,178, 7,777,165, and 7,728,267, and U.S. Published Applications 2009/0283936 and 2009/0283643, all of which are incorporated by reference in their entireties. Improvements would be desirable.

### SUMMARY OF THE INVENTION

Structural materials have utilized elastomeric open-cell foams as a space filler that can drastically change volume from a compressed state to an expanded state. Although use of such foam materials allows a relatively small stowed volume, such open-celled foams can be heavy and can take a large amount of force to compress. This can result in a need for heavy onboard actuation equipment to compress the foam material.

According to an aspect of the invention, a foam material for a structure is an open-cell foam.

According to another aspect of the invention, a foam material is an open-cell foam with ordered voids.

According to yet another aspect of the invention, an open-cell foam material has a repeated pattern of interconnected voids

According to still another aspect of the invention, a foam material has ordered voids of different sizes.

According to a further aspect of the invention, a foam material includes a continuous material matrix that defines voids within the continuous material matrix, wherein the continuous matrix material includes a shape memory polymer.

According to a still further aspect of the invention, a foam material includes a continuous material matrix that defines voids within the continuous material matrix, wherein the continuous matrix material is itself a foam. The continuous matrix material may be a gas-expanded foam continuous material or a syntactic foam material.

According to another aspect of the invention, a foam material has ordered voids of at least two sizes. The relatively small voids may be interspersed amid relatively large voids. The relatively large voids may be packed substantially at a closest packing.

According to yet another aspect of the invention, a foam material includes a continuous material matrix that defines voids within the continuous material matrix. The voids are ordered within the matrix. The foam material is an open-cell foam material, with the voids being parts of an interconnected network of voids. Some of the voids have a different volume than other of the voids.

According to still another aspect of the invention, a foam material includes a continuous material matrix that defines voids within the continuous material matrix. The voids are ordered within the matrix. The foam material is an open-cell foam material, with the voids being parts of an interconnected network of voids. The continuous material matrix includes a shape memory polymer.

According to a further aspect of the invention, a foam material has spherical voids with fillets connecting them.

According to a still further aspect of the invention, an aircraft structural member, such as part of a wing, includes a foam material.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The annexed drawings, which are not necessarily to scale, show various aspects of the invention.

FIG. 1 is an oblique view of a foam material in accordance with an embodiment of the invention.

FIG. 2 is a top sectional (or side) view of the foam material of FIG. 1.

FIG. 3 is an oblique view of a unit cell of a mold insert used in producing the foam material of FIG. 1.

FIG. 4 is an oblique view of a unit cell of a mold insert used in producing a foam material according to an alternate embodiment of the invention.

FIG. 5 is an oblique view of a unit cell of a mold insert used in producing a foam material according to another alternate embodiment of the invention.

FIG. 6 is an oblique view of the mold insert of FIG. 5 used in producing the foam material according to the another alternate embodiment of the invention.

FIG. 7 is an oblique view of a unit cell of a mold insert used in producing a foam material according to yet another alternate embodiment of the invention.

FIG. 8 is an oblique view of the mold insert of FIG. 7 used in producing the foam material according to the yet another alternate embodiment of the invention.

FIG. 9 is an oblique view of a unit cell of a mold insert used in producing a foam material according to yet another alternate embodiment of the invention.

FIG. 10 is an oblique view of the mold insert of FIG. 9 used in producing the foam material according to the yet another alternate embodiment of the invention.

FIG. 11 is an oblique view of a mold insert used in producing the foam material according to still another alternate embodiment of the invention.

FIG. 12 is an oblique view of a unit cell of a mold insert used in producing a foam material according to a further alternate embodiment of the invention.

FIG. 13 is an oblique view of the mold insert of FIG. 12 used in producing the foam material according to the further alternate embodiment of the invention.

FIG. 14 is an oblique view of a mold insert used in producing the foam material according to a still further alternate embodiment of the invention.

FIG. 15 is a sectional view of a foam member used as part of an aircraft wing, in accordance with another embodiment of the invention.

FIG. 16 is an oblique view of a portion of an airframe structure (a wing) in accordance with still another embodiment of the invention.

### DETAILED DESCRIPTION

A foam material is an open-cell material, with ordered voids forming an interconnected network of voids within a continuous material matrix. The voids may be spherical. There may be different sizes of voids, with the smaller voids located between larger voids. The continuous material matrix may include a polymer material, such as a shape memory polymer. Balloons or spheres may be included within the continuous material matrix to further reduce the density of the foam material. The foam material may have a global density of 20% or less. The density of the material may vary, perhaps continuously, with position within the foam material. The foam material may be made by producing an array of a removable material corresponding to the shape of the voids, molding or otherwise forming the continuous material matrix around the removable material, and then removing the removable material, such as by dissolving the removable material with a solvent. The resulting foam material may be used as a structural material.

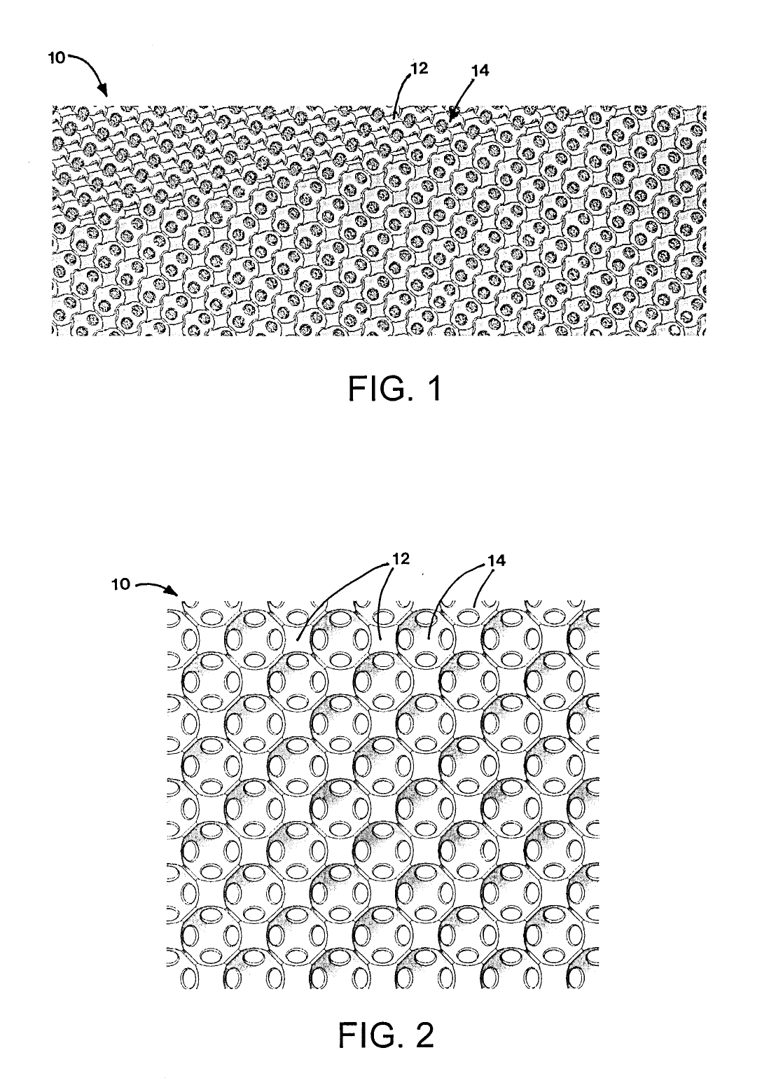

FIGS. 1 and 2 show a foam material 10 that has a continuous material matrix 12, and voids 14 within the continuous material matrix 12. The foam material 10 is an open-cell foam material, with the voids 14 constituting an interconnected network of voids. This interconnected network of the voids 14 allows the foam material 10 to be compressed without damaging the continuous material matrix 12. Since the voids 14 are interconnected, gas (or other fluid) within the voids 14 can be squeezed out of the voids 14 without breaking the portions of the continuous material matrix 12 that is between the voids 14. This is in contrast to closed-cell foam materials, in which material between voids is torn or otherwise damaged during the process of compressing the foam material.

The voids 14 are ordered within the continuous matrix material 12. An ordered structure is a repeating structure, in which the voids 14 have some repeating spatial relationship to immediate neighbors and more-distant neighbors. The repeating structure repeats in a unit cell. Examples of repeating structures include face-centered-cubic close-packed structure, body-centered-cubic close-pack structure, and rectangular structure.

The repeating structure of the voids 14 is shown as a face centered cubic structure that repeats throughout the entire foam material 10. However it is not required that the same structured ordering of the voids 14 repeats throughout the entire foam material. In addition, though the voids 14 are all shown as having the same size, as an alternative different sizes of voids may be used. The different sizes of voids may involve smaller voids being interspersed between larger voids, to provide a larger void fraction than can be accomplished with only a single size of spherical voids. Alternatively or in addition, different parts of the foam material may utilize different sizes of voids.

The voids 14 are illustrated as spherical, having what appear to be point contacts between them that allow fluid communication between the voids 14. The apparent point contacts will in fact be more than just points. Alternatively the voids 14 may have fillets that provide broader connections between adjacent of the voids 14. This is explained in greater detail below.

The material of the continuous material matrix 12 may be any of a variety of suitable materials. One desirable characteristic of the continuous material matrix 12 is that the material is elastically flexible, so that is can reversible change shape. The material may be a suitable flexible polymer. Example suitable materials for the continuous material matrix 12 include polyurethane and silicone.

The continuous material matrix 12 may itself be a foam, such as a solid polymer foam. Such a solid polymer foam may be a gas-expanded solid foam in which relatively small voids within the continuous are located substantially randomly within the continuous material matrix 12, with the gas-expanded small voids having a range of sizes. Alternatively the solid foam continuous material matrix 12 may be a syntactic foam material, with small hollow spheres or balloons mixed in with the continuous material. The use of a foam as a continuous material may advantageously reduce the weight of the foam material 10.

Another desirable feature for the continuous material matrix 12 is to have shape memory properties, the ability to return to a certain shape when released and/or otherwise treated, such as by heating. Having shape memory properties is desirable when the foam material 10 will be initially in a non-use configuration, such as when the foam material 10 is stored in a compressed stowed configuration, in order to save space, with the foam material 10 later to be deployed from the compressed configuration. Utilizing a continuous material matrix 12 with shape memory properties helps avoid the material adapting to the compressed stowed configuration in such a way as to require an external force to be applied to expand the foam material 10. Accordingly the continuous material matrix 12 may include a polymer material with shape memory properties.

As another alternative the continuous material matrix 12 may include a liquid or colloidal material, such as a gel. For example the continuous material matrix 12 may include a gel within a solid (resiliently flexible) framework or skin.

In the illustrated embodiment the foam material 10 has its voids 14 in a hexagonal close packed structure arrangement. Other ordered arrangements of voids may be used instead. Some of these other ordered arrangements of voids are described below.

The voids 14 may constitute a substantial volume fraction of the foam material 10, such that the foam material has a low density. The density of a foam is the volume fraction of the foam that contains solid or liquid material outside of the voids, when the foam is in an uncompressed state. The density may be a local or a global quantity. Whether local or global, the density is a quantity that is averaged over a volume that includes a large number of voids. Related to density is “local concentration,” which as used herein refers to a volume-averaged concentration (void fraction or fraction of the continuous material matrix (density), or the non-gas (solid or liquid) part of the continuous material matrix) averaged over a volume of the foam material that includes large number of voids.

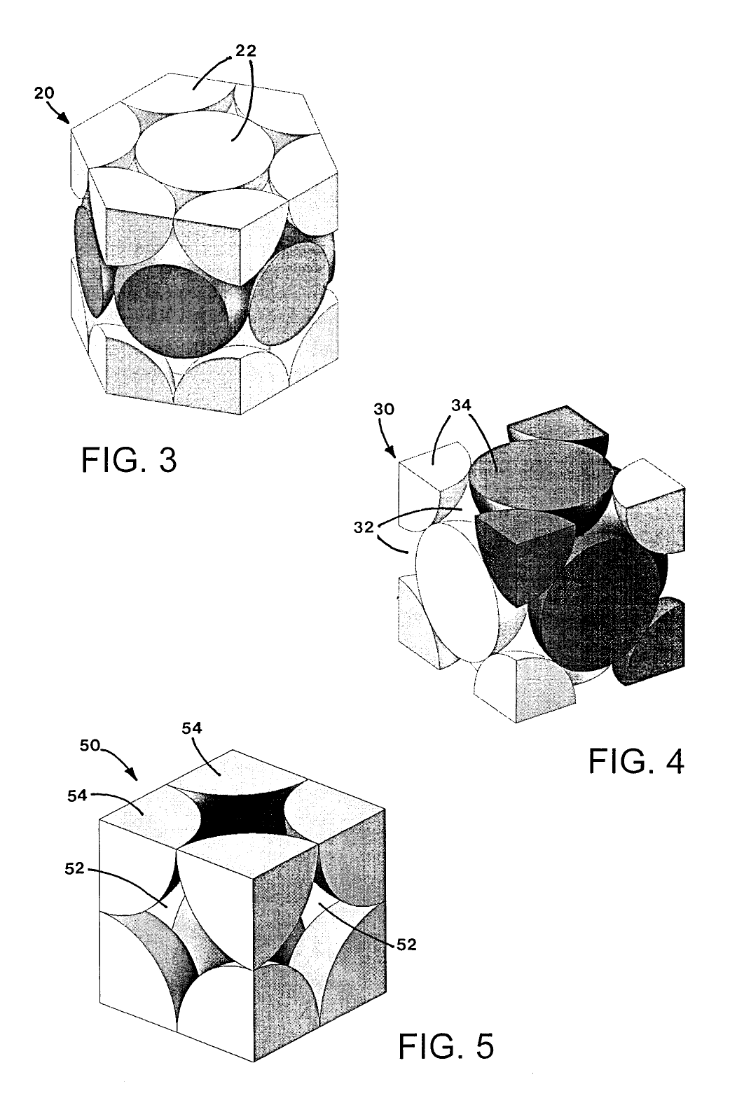

The foam material 10 may be made by a casting process, using a mold that has an insert that corresponds in shape to the network of the voids 14. FIG. 3 shows a unit cell of a mold insert 20 used for producing the hexagonal close packed arrangement of voids 14 in the foam material 10 (FIG. 1). The mold insert 20 has a number of spherical elements 22, only parts of which are shown in the illustrated unit cell, that correspond in size and arrangement to the voids 14 to be produced. In use the mold insert 20 is placed into a mold cavity (not shown). Then the continuous material matrix 12 (FIG. 1) is formed around the mold insert 20 by pouring, injecting, or otherwise introducing material into the mold cavity in the spaces left open in the mold insert. The material for the continuous material matrix 12 may be introduced in a liquid form, then cured or otherwise made solid. Finally the mold insert 20 may be removed to leave the voids 14, surrounded by the continuous material matrix 12, constituting the foam material 10.

The mold insert 20 may be made of a material that can be dissolved with a suitable solvent, in order to allow the mold insert 20 to be removed after the formation of the continuous material matrix (FIG. 1). Examples of soluble materials include sugar and salt, which are water soluble; water-soluble rapid prototyping materials, such as those describe in U.S. Pat. No. 6,070,107; and polystyrene foam materials, which are soluble in acetone. Many other examples of soluble materials could be used as alternatives.

The mold insert 20 may alternatively be made of a material that can be melted and removed after the formation of the continuous material matrix 12 (FIG. 1). An example of a suitable meltable material is wax.

The mold insert 20 may be made by the following process. A stereolithography or a selective laser sintering process may be used to make a model (not shown) out of plastic, with the model having the same size and shape as is desired for the mold insert 20. The model can then be dip-coated with a suitable ceramic material by dipping the plastic model into a slurry containing the ceramic material. After the ceramic solidifies around the outside of the plastic model the model, with its ceramic coating, may be placed in an oven and heated. This burns the plastic of the model out, leaving only the hollow ceramic shell. This hollow ceramic shell can be filled with the material for the mold insert 20. After the mold insert material sets, the ceramic shell can be broken into pieces and removed, leaving the finished mold insert 20.

What follows are descriptions of several variations of the foam material 10, with different ordered configurations of voids. These embodiments are illustrated in terms of the mold inserts used to produce them. This is done for convenience only. In the foam materials themselves the voids correspond to the elements shown in the figures, and the continuous material matrix is located between the elements shown in the figures. For simplicity of explanation, reference numbers indicating mold insert elements of the figures may be referred to in the text as voids, and reference numbers indicating spaces between the mold insert elements in the figures may be referred to in the text as continuous material matrices.

FIG. 4 is an oblique view of a unit cell of a face centered cubic close packed structure that may be used for a foam material 30, with a series of interconnected voids 34 interspersed among a continuous material matrix 32 between the voids 34. The face centered cubic close packed structure of the foam material 30 has a density of 0.26 (26%), assuming that the continuous matrix material 32 has no voids within it. The voids thus take up 74% of the volume of the foam material 30. This is the same density and void fraction as a hexagonal close packed structure, such as is present for the foam material 10 (FIG. 1). This is the smallest density that can be achieved by using spherical voids of uniform size.

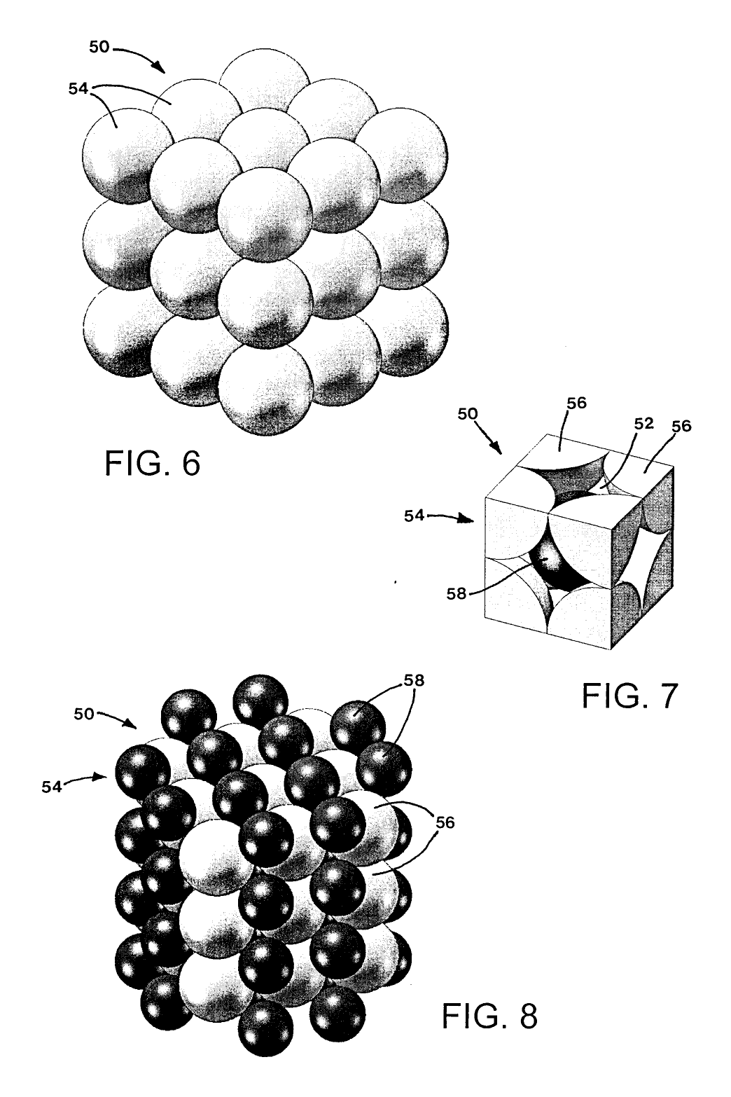

FIGS. 5 and 6 show a rectangular packing structure for a foam material 40, with a series of interconnected voids 44 being interspersed between a continuous matrix material 42 that is between the voids 44. A rectangular packing structure of identically-sized spheres produces a density of 0.48 (48%), with the voids 44 taking up 52% of the volume of the foam material.

FIGS. 7 and 8 illustrate a configuration of voids 54 in a foam material 50 that has a continuous material matrix 52 that is between the voids 54. The voids 54 include relatively large voids 56 that are in rectangular packing structure, similar to that of the voids 44 of the foam material 40 (FIG. 5). Interspersed between the relatively large voids 56 are relatively small voids 58. The relatively small voids 58 are sized to fit in between the relatively large voids 56 without disturbing the rectangular configuration of the relatively large voids 56. The relatively small voids 58 increase the void fraction of the foam material from 52% (the void fraction for a rectangular void structure with spherical voids of a single size) to 73% (density of 0.27, or 27%), nearly the void fraction for hexagonal close packed or face centered cubic close packed arrangement.

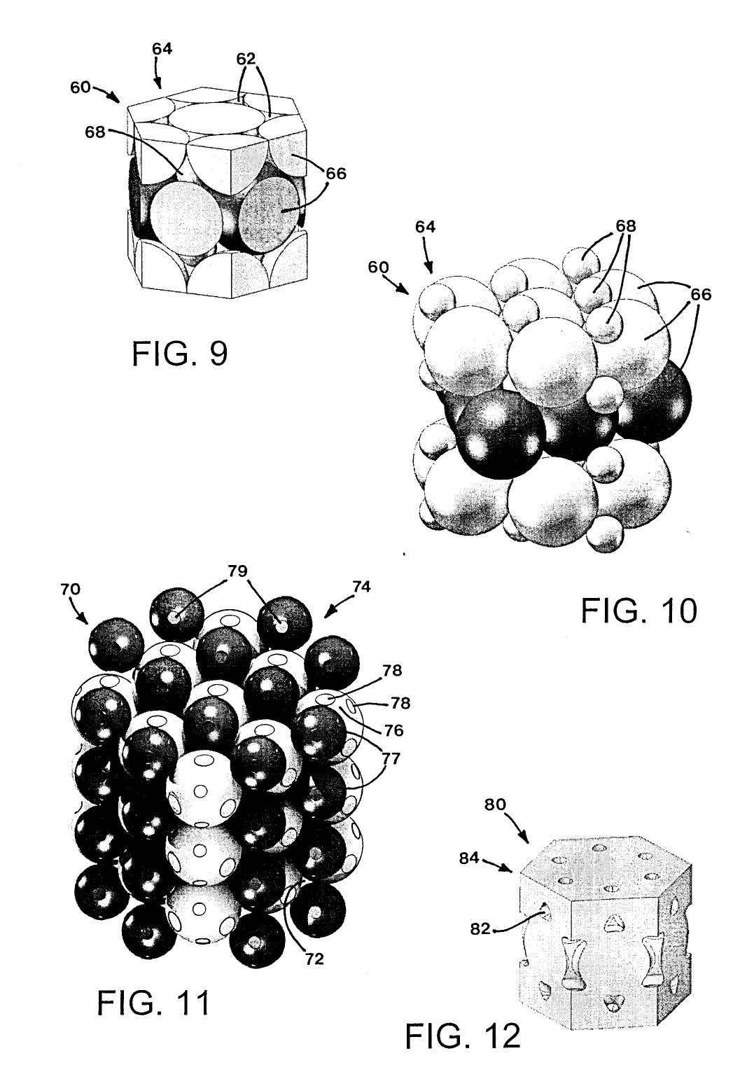

FIGS. 9 and 10 illustrate a configuration of voids 64 in a foam material 60 that has a continuous material matrix 62 that is between the voids 64. The voids 64 include relatively large voids 66 that are in hexagonal close packed structure, similar to that of the voids 14 of the foam material 10 (FIG. 1). Interspersed between the relatively large voids 66 are relatively small voids 68. The relatively small voids 68 are sized to fit in between the relatively large voids 66 without disturbing the hexagonal configuration of the relatively large voids 66. The relatively small voids 68 increase the void fraction of the foam material from 74% (the void fraction for a hexagonal void structure with spherical voids of a single size) to 79% (density of 0.21, or 21%).

The void fraction can be increased further than by addition of a second set of voids of a smaller size than the primary (relatively large) voids. One possibility is to add a third (or even fourth) set of even smaller voids. It is possible to use a range of void size to increase the void faction of the material even further, for example to 90% (density of 0.1, or 10%) to 95% (density of 0.05, or 5%), or even to 96.5% (density of 0.035, or 3.5%). In addition, use of multiple sizes of voids may have other advantages, such as in controlling thermal properties in the foam. Multiple sizes of voids may be used to reduce cell wall thicknesses in the foam, to minimize the time needed to rapidly heat or cool the foam. This may allow for a faster response time for the foam material 10. For example, control of cell wall thickness enables ultra-rapid heating of shape memory polymers. Another reason to use the smaller voids is to enable higher compression ratios in the foam, because the smaller voids can be used to reduce stress concentrations in the foam cell walls.

Another possibility is revision of the spherical shapes of the voids to add fillets, protrusions from the spherical void shapes where the voids contact with one another. The fillets transform the near-point contacts between adjacent spherical voids to wider channels. The fillets may be circular-cross-section protrusions having disk-shape faces.

FIG. 11 shows a foam material 70 which is a modification of the foam material 50 (FIG. 8) to add small fillets. The foam material 70 includes a continuous matrix material 72 amid voids 74. The voids 74 include relatively large voids 76 and relatively small voids 77. The voids 76 and 77 include corresponding fillets 78 and 79 where the voids 76 contact one another, and where the voids 76 contact the voids 77. The fillets 78 and 79 may have diameters that are from 2% to 60% or the radii of the voids 76 and 77, to give an exemplary range. The foam material 70 has a void fraction that may provide a lighter (lower density) for the foam material 70 relative to the foam material 50. The fillets 78 and 79 eliminate sharp edges that would otherwise form between adjacent (contacting) spheres (voids). These sharp edges would create thin sections in the foam cell walls, and the thin sections heat faster than the thicker wall sections. When a polymer foam is rapidly heated, such as when a shape memory polymer foam is heated to raise its temperature by 50 degrees C. in under 5 seconds, those thin sections of the foam will overheat and literally burn out, before the thicker wall sections have gotten warmed up. By filleting all the sphere contacts, the thin places in the foam cell wall can be eliminated. This in turn allows the foam to be heated far more rapidly than in prior foams.

FIGS. 12 and 13 show a foam material 80 that is a modification of the foam material 60 (FIG. 10), to add large fillets. The foam material 80 includes a continuous matrix material 82 amid voids 84. The voids 84 include relatively large primary voids 86 and relatively secondary small voids 87. The voids 86 and 87 include corresponding fillets 88 and 89 where the voids 86 contact one another, and where the voids 86 contact the voids 87. The foam material 80 has a void fraction of 85% (density of 0.15), which provides a lighter foam material 80 (lower density) than the foam material 60.

The embodiments described above have all involved the same repeating pattern of voids throughout the entire foam material. However, as an alternative, the foam materials in any of the above-described embodiments may have differences in configurations in different parts of the foam material. Differences may include differences in the size of the voids, differences the configuration of the voids, and/or differences in the void fraction, among other possible differences.

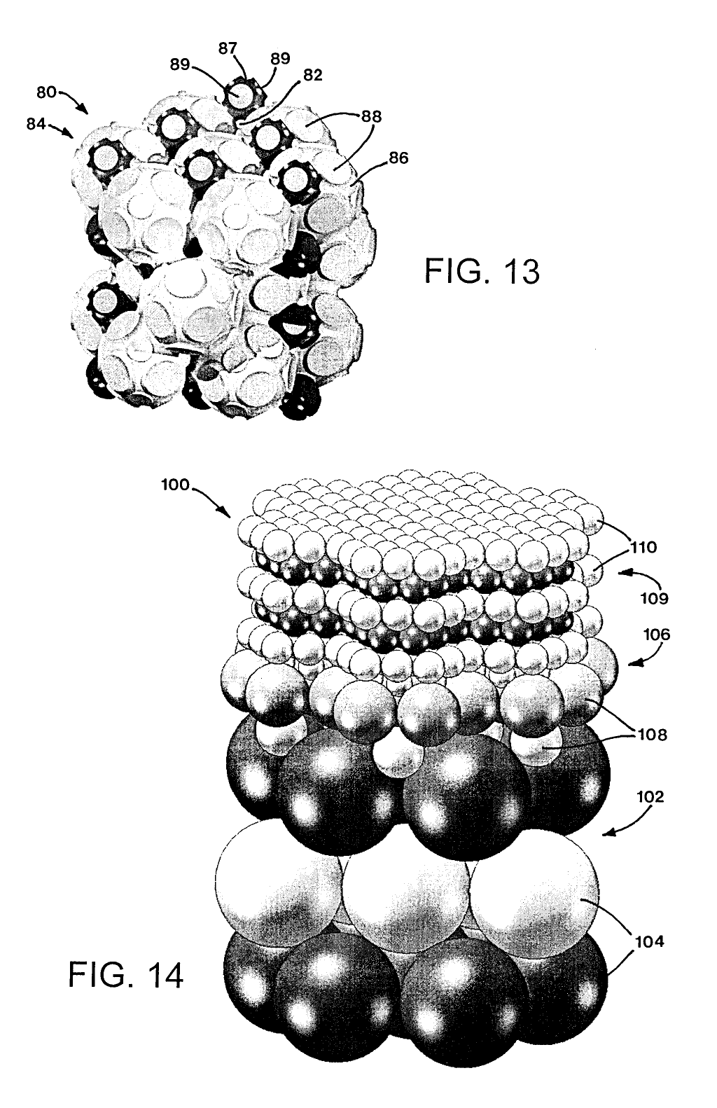

FIG. 14 shows a foam material 100 that has different configurations in different portions of the material 100. In a first portion 102 the foam material 100 has large voids 104. In a second portion 106 the foam material 100 has medium voids 108. In a third portion 109 of the foam material 100 has small voids 110. The first portion 104 may be located in a center region of the foam material 100, far from the edges or boundaries of the foam material 100. The third portion 109 may be close to the boundary of the foam material 100, so as to form a skin of the foam material 100. The second portion 106, between the portions 102 and 109, may serve as a transition between the large voids 104 in the bulk of the foam material 100, and the small voids 110 at and near the surface of the foam material 100.

The foam material 100 is only one example of a material with a positional variation in its voids. The size of the voids may change with position, as was described above with regard to the foam material 100. Alternatively or in addition the configuration of the voids, the type of packing of them, may change. For example the voids may change from a face centered cubic or hexagonal close packing, to a rectangular packing. As another example, relatively small voids may be present in one location in the foam material, such as in the bulk of the material, and not in other locations in the material, such as at or near boundaries in the material. Fillets may change size at different locations in the material, changing the local density of the material in another possible way. Some of the voids may be eliminated in areas where a higher local density is desired.

By changing the density of the foam material locally, the properties of the foam material, such as local tensile strength, may be controlled. For example, use of larger major sphere sizes results in thicker cell walls. This in turn results in a higher local tensile strength to the foam, making it easier to attach to other materials. This is in contrast with conventional foams with random cells; such foams tend to have very low and widely variable tensile strength. Such conventional foams can be difficult to attach to other materials in a reliable manner (for conventional foams of around 20% density, for example). Besides varying the local tensile strength, varying the foam density, such as by varying the sphere diameter (the diameter of the largest voids), can vary the thermal response time.

The foam materials described herein is that the foam materials have a continuous open cell structure. One advantage from this continuous open cell structure is that it prevents damage to the material when the foam is compressed. Another advantage is that the continuous open cell structure allows coating of the foam with thin film materials, which for example might be used for heating or cooling the foam. For example thin conductive polymer films as heater layers, such as is described in published application US 2010/0243808 A1, the description and figures of which are incorporated herein by reference. A continuous open cell foam can be coated all the way through, whereas a non-continuous or closed cell foam cannot be so thoroughly coated. Another possible use for coating is to coat the foam to change its electromagnetic properties.

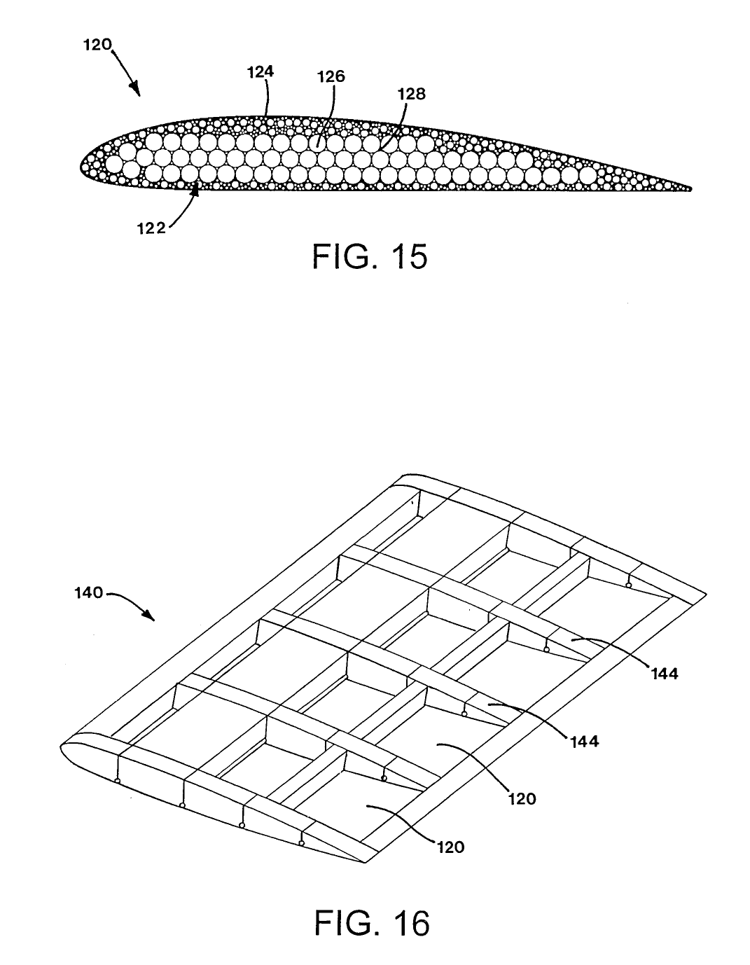

FIG. 15 is a cross-sectional view of an aircraft wing section foam material piece 120, showing a local density change of continuous matrix material 121 from a bulk 122 of the foam material 120, to an outer skin 124 of the foam material 120. In the bulk 122 the voids 126 and 128 are relatively large, with secondary (smaller) voids 128 amid the primary (larger) voids 126. As one moves from the bulk 122 to the skin 124 at an outer surface of the aircraft wing, the secondary voids 128 are eliminated, the voids are made smaller, and some of the voids in the pattern are eliminated, providing a local increase in density, which may be at a maximum at the skin 124. The local density at the skin 124 may be twice (or more) the local density in the bulk 122. For example the density may be 16% in the bulk 122, and 33% at the skin 124. In another example the density 20% may be in the bulk 122, varying all the way up to 100% at the skin 124. The change in local density may be gradual, avoiding abrupt changes, so that the local density may be graded. For example the same foam material may have gradations of local density of 100%, 90%, 70%, 50%, 33%, and 20%, avoiding abrupt transition of local density that could weaken material.

The difference in local density may be done to provide more material, and thus enhanced material properties, in certain regions of the foam material. Added strength may be desirable for areas of the foam material that may have to carry structural load, for example.

The voids in the various embodiments may have any of a variety of suitable sizes. The size of the voids may be selected based on the size of the foam material piece, with the voids for example having diameters at most an order of magnitude smaller than a dimension of the foam material piece, such as a length, width, or height of the piece. The size of the voids may also be a function at least in part of the desired properties of the material. Using larger major sphere diameters will increase the local tensile strength of the foam. Using smaller major sphere sizes will reduce the thermal response time in rapid heating and cooling applications (because smaller spheres leads to thinner cell walls). Thus the foam material may be configured to make a trade-off between these different properties.

In addition, it may be observed that changing the size of the voids, while keeping the void fraction the same, changes the amount of surface area of the foam, since volume is proportional to the cube of a void's diameter, while surface area of a void is directly proportional to the void diameter. Thus halving the diameter of each void, while keeping the overall void fraction the same, doubles the available surface area in the material.

The foam materials described above offer many advantages over prior foam materials. The foam materials have low density, which reduces weight, while also letting the foam material be compressed into a small volume. For example a 20% dense foam may be compressed by a ratio of 4:1, to 25% of its uncompressed volume. Theoretically, a 20% dense foam may be compressed to 20% of its uncompressed value, but it may be beneficial to avoid a maximum compression, since to do so may cause damage to the continuous matrix material.

The foam materials described above also may have advantageous material properties when compared with other types of foam materials, such as foam materials without ordered voids, for example closed-cell foam materials with voids produced at random locations, for example by gas generation. The foam materials described herein may have better strength than certain prior-art foam materials, for example having better tensile strength.

The foam materials described herein may be utilized in any of a number of suitable applications. FIG. 16 shows the aircraft wing foam material 120 (or portions of it) as part of an aircraft wing 140. The foam material 120 is one of a number of foam material pieces 120 alternating with thin knuckled foldable ribs 144. Such ribs involve multiple sections in the chord direction that allow the wing to be stowed in a curved or folded form. Further details regarding such ribs may be found in a concurrently-filed, commonly-owned application, “Aircraft Wing With Knuckled Rib Structure” (attorney docket 10-1186), the description and figures of which are incorporated herein by reference.

Examples of other aircraft wing structures may be found in U.S. Pat. Nos. 7,939,178, 7,777,165, and 7,728,267, and U.S. Published Applications 2009/0283936 and 2009/0283643, all of which are incorporated herein by reference in their entireties. The use of the foam material 120 may allow the wing 140 to be stowed in a relatively compact space (volume), and deployed only when needed for flight. Having a foam material with shape memory properties may be particularly advantageous for the foam material, in that it may allow foam material pieces to be stowed in a compressed state for a long time (as much as months or years) without retaining a “memory” in their stowed state. The wing 140 may include heating elements or mechanisms (not shown) for heating the foam material 120 to soften it and/or to activate shape memory properties of the material 120. Mechanical and/or electrical mechanisms (not shown) may be utilized for controlling expansion, contraction, shape change, and/or shape retention of the foam material 120, for example in increasing or decreasing the wingspan of the wing 140. Respective openings 150 and 154 in the foam material 120 and the ribs 144 may allow for passage of other devices/mechanisms of the wing 140, such as control mechanisms and/or expandable structure for expanding or contracting the length of the wing 140. The structure shown in FIG. 16 also may be utilized in other airframe structure parts, for example in expandable control surfaces.

Other possible applications for the foam materials described are in structural materials where weight and/or storage volume are important, as is perhaps the ability to be able to be stored without taking on the storage container. Examples of such applications included space structures, such as structures for satellite dish antennas, which may be launched in a compact shape, and then only later expanded to final shape and form. Space structures may need to be stowed in a compact form, and remain stowed until launch and deployment of the missile. Such structures may have diameters of 20 or 30 meters, with spherical voids within them having diameters of 10 to 15 cm, for example.

Another possible application is in robotic structures. Again the structures may need to be maintained in a stowed configuration for a long period of time before being deployed reliably and without use of undue force. Structures for this sort of device may be much smaller, for example being the size to fit into a backpack or similarly-sized container. Such structures may use foam materials with voids having diameters on the order 0.25 cm.

Many values of density or local density are described with regard to the various embodiments. A full range of intermediate values of local density are possible, and should be considered as disclosed herein as possibilities. For example, all intermediate values of density between 5% and 100% are possible for all or part of a foam material.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A foam material comprising:
a continuous material matrix that defines voids within the continuous material matrix;
wherein the voids are ordered within the matrix;
wherein the foam material is an open-cell foam material, with the voids being parts of an interconnected network of voids; and
wherein some of the voids have a different volume than other of the voids.

2. The foam material of claim 1, wherein the voids are spherical.

3. The foam material of claim 1, wherein the voids have a spherical shape with fillets

4. The foam material of claim 1, wherein the continuous material matrix includes a polymer material.

5. The foam material of claim 4, wherein the polymer material is a shape memory polymer.

6. The foam material of claim 1, wherein the continuous material is a solid material.

7. The foam material of claim 1, wherein the continuous material is a solid foam continuous material.

8. The foam material of claim 7, wherein the solid foam continuous material is a gas-expanded foam continuous material.

9. The foam material of claim 7, wherein the solid foam continuous material is a syntactic foam material.

10. The foam material of claim 1, wherein the voids include relatively small voids interspersed amid relatively large voids that are larger than the relatively small voids.

11. The foam material of claim 10, wherein the relatively large voids are packed substantially at a closest packing.

12. The foam material of claim 10, wherein the relatively large voids account for at least 70% of the volume of the foam material, when the foam material is uncompressed.

13. The foam material of claim 12, wherein the relatively large voids and the relatively small voids account for at least 85% of the volume of the foam material, when the foam material is uncompressed.

14. The foam material of claim 1, wherein the foam material has a density of 0.20 or less.

15. The foam material of claim 1, wherein a local density of the foam material varies as a function of position within the foam material.

16. The foam material of claim 15, wherein the local density varies substantially continuously as a function of the position within the foam material.

17. The foam material of claim 16, wherein the local density at a first location within the foam material is at least twice the local density at a second location within the foam material.

18. The foam material of claim 16, wherein the local density of at least a portion of the foam material is substantially 100%.

19. The foam material of claim 1, wherein the foam material is part of an airframe or robotic structure.

20. A foam material comprising:
a continuous material matrix that defines voids within the continuous material matrix;
wherein the voids are ordered within the matrix;
wherein the foam material is an open-cell foam material, with the voids being parts of an interconnected network of voids; and
wherein the continuous material matrix includes a shape memory polymer.
